(19) United States
(12) Patent Application Publication
(10) Pub. No.: US 2005/0232416 A1
(43) Pub. Date: Oct. 20, 2005

(54) Method and device for determining a result

(75) Inventors: Steffen M. Sonnekalb, Taufkirchen (DE); Andreas Wenzel, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/111,096

(22) Filed: Apr. 19, 2005

(30) Foreign Application Priority Data
Apr. 19, 2004 (DE) 10 2004 018874.2

(51) Int. Cl. H04L 9/00

(52) U.S. Cl. 380/46

(57) ABSTRACT

Device for determining a result includes a unit for determining a first and a second intermediate result, wherein the result depends on the first and the second intermediate result, and a unit for randomly determining a sequence in which the unit for determining executes the determination of the first and the second intermediate result.

### CROSS-REFERENCE TO RELATED APPLICATION

This application claims priority from German Patent Application No. 10 2004 018 874.2, which was filed on Apr. 19, 2004, and is incorporated herein by reference in its entirety.

### BACKGROUND OF THE INVENTION

1. Field of the Invention

The present invention relates generally to the determination of a result and is, for example, beneficial in determining results as they occur during the execution of a cryptographic algorithm.

2. Description of the Related Art

In some cryptographic algorithms, so-called S-boxes are used. Examples of such cryptographic algorithms are, for example, the DES (data encryption standard) and the AES (advanced encryption standard) algorithms. FIG. 4 schematically shows the operation of the DES algorithm. For encrypting the data, they are first divided into 64-bit blocks 900 to process them blockwise. The blocks 900 are then first subjected to permutation 902. After that, the permuted 64-bit data block is divided into two 32-bit data blocks 904 and 906. These 32-bit blocks 904 and 906 are iteratively subjected to the following operations in 16 so-called rounds. First, the contents of the data block 906, designated R in FIG. 4, are mapped to the data block 904 of the next round, designated L in FIG. 6. This mapping is indicated by 908. In order to obtain the new contents of the data block R 906 for the next round, the current contents of the data block 906 are subjected to an expansion operation E 910 to obtain a 48-bit data block from the 32-bit data block according to a predetermined supplementation rule according to which certain bits are doubled. In a step 912, the 48-bit data block is then encrypted by an XOR operation 912 with a 48-bit round key which is different for each round, but is derived from one and the same 56-bit key 914 by an operation 916 which is not further discussed herein.

The encrypted and expanded 48-bit data block is again mapped to a 32-bit data block in the so-called S-boxes S1, S8 mentioned above. For this, each S-box maps six different ones of the 48 bits of the encrypted data block to four bits, respectively, wherein the mapping rules of the individual S-boxes are mostly set by standards. Following this S-box mapping 918, the resulting value is again subjected to a permutation P 920, and then the permuted 32-bit block is subjected to an XOR operation 922 with the 32-bit data block L 904 of the previous round. The XOR-combined 32-bit data block represents the new 32-bit data block R 906 for the next round. This round defined by the steps 908, 910, 912, 918, 920 and 922 is performed 16 times. After the 16 rounds, the resulting 32-bit data blocks L and R (904, 906) are again joined into a 64-bit data block and subjected to an output permutation 924 inverse to the permutation 902, the result being the final 64-bit output data block in encrypted form indicated by 926.

When executing a cryptographic algorithm, such as the DES algorithm explained by way of example above, on a hardware basis, information on the processed operation and the used data, such as particularly the round keys, are leaked by side channels, such as current supply or electromagnetic radiation. This information may then be used with the aid of DPA (differential power analysis) or DMA (differential electro-magnetic analysis) to spy out secrets, such as the master key of the DES algorithm on which the round keys are based. This may be illustrated with respect to the DES algorithm of FIG. 4 as follows. As mentioned above, the mapping rules of the various S-boxes are known. In addition, each access to the power profile or the profile of the electromagnetic radiation of the circuit executing the DES algorithm is detectable by certain characteristic profiles correlating with the input addresses in the S-boxes. With the DES algorithm, there is a particular danger that the input addresses arriving in the S-boxes are encrypted with the secret round keys which are derived from the secret master key 914 in a known way predefined by the standard. For this reason, it is possible to draw conclusions as to the master key 914 from current profile analyses or analyses of the emitted electromagnetic radiation during the mappings 918 by means of the correlation with the current profile of the circuit implementing the algorithm.

As mentioned above, the crypto-algorithms DES and AES are not the only ones in which data are encrypted by means of S-boxes. In all these algorithms, a differential current analysis or an analysis of the emitted electromagnetic radiation allows an attack on secret data in the way indicated above. If unprotected S-boxes are used for memory encryption in a microcontroller, even software crypto-algorithms running on the processor and getting data from the encrypted memories may be attacked via a DPA attack.

Avoiding this therefore requires minimizing the usable radiation or hiding it so that it does not become usable or only becomes usable with large effort. Up to now, this problem has not been solved in an adequate way. Although it is possible to enhance the security against DPA attacks in this respect by the use of full-custom dual-rail circuit technology, the use of this circuit technology implies a very large effort which does not seem justified in all applications. Further possible approaches would be, for example, a randomized program execution, which could, however, be recognized from the leakage profile, the execution of critical calculations with data protected by a one-time pad, the generation of noise, the introduction of jitter into the code execution and/or the clock of the system, or the like. These possibilities, however, are not very effective, in part, or they are blocked by patents of third parties.

### SUMMARY OF THE INVENTION

It is an object of the present invention to provide a scheme for determining a result allowing enhanced security against cryptographic attacks, such as DPA or DEMA attacks, with acceptable effort.

In accordance with a first aspect, the present invention provides a device for determining a calculation result, having a unit for determining a first intermediate result and a second intermediate result, wherein the result depends on the first intermediate result and the second intermediate result; and a unit for randomly determining a sequence in which the unit for determining executes the determination of the first intermediate result and the second intermediate result.

In accordance with a second aspect, the present invention provides a method for calculating a result, having the steps of determining a first intermediate result and a second intermediate result; wherein the result depends on the first intermediate result and the second intermediate result, and wherein the method further has the step of randomly determining a sequence in which the steps of determining are executed.

In accordance with a third aspect, the present invention provides a computer program with a program code for performing the above-mentioned method, when the computer program runs on a computer.

### BRIEF DESCRIPTION OF THE DRAWINGS

Preferred embodiments of the present invention will be explained in more detail in the following with respect to the accompanying drawings, in which:

FIG. 1 is a block circuit diagram of a device for determining a result according to an embodiment of the present invention;

FIG. 2 is a block circuit diagram of a device for determining a result according to a further embodiment of the present invention;

FIG. 3a is a schematic illustration of the structure of the input data block prior to the S-box substitution in a DES algorithm;

FIG. 3b is a schematic illustration of the arrangement of S-box look-up tables in a linear address space according to an embodiment of the present invention;

FIG. 3c is a schematic illustration of the structure of an address for substituting a 6-bit word and/or block from the input data block of FIG. 3a for access to one of the look-up tables of FIG. 3b according to an embodiment of the present invention;

FIG. 3d is a pseudo program code for the implementation of a random execution of the S-box operations in a substitution operation of a round of a DES algorithm according to an embodiment of the present invention; and

FIG. 4 is a diagram for illustrating the DES algorithm.

### DESCRIPTION OF THE PREFERRED EMBODIMENTS

A central idea of the present invention is that a reduction of the averaged leakage information when executing cryptographic algorithms may be achieved by determining the results or partial results which occur in the course of the execution of this algorithm and are themselves based on intermediate results such that the sequence in which the intermediate results are determined is determined randomly. The present invention makes use of the fact that, on the one hand, it is irrelevant for the determination of a result from two intermediate results with respect to the result of the determination in which order the intermediate results are determined, that, however, on the other hand, the leakage information detectable from outside, i.e. the correlation of secret data with the power consumption and/or the emitted electromagnetic power or the like, is reduced when the intermediate results are determined in random order, because even when the same input data are used for the algorithm when executing the cryptographic algorithm, the resulting leakage profiles differ. This increases the number of necessary averagings on the attacker side which can be decisive for success or failure of an attack.

The present invention is particularly advantageous when the determination of the intermediate results includes looking up in one or more look-up tables, because, especially in the case of memory accesses, correlations on the address, as they occur, for example, in the S-box accesses of known block ciphers, such as the DES or AES algorithms, represent a large leakage risk. In particular, an effective hardware protection, for example by dual-rail circuit technology, is very hard to realize here because of the mostly very extensive memory systems. However, an encryption round in block ciphers generally consists of several independent S-box accesses, namely eight parallel, mutually independent accesses to eight different S-boxes in the case of the DES and 16 independent accesses to a common S-box in the case of the AES, so that the invention may be used in a particularly effective way here with respect to the S-box accesses because the number of possible execution sequences from which one is randomly determined is large.

One embodiment of the present invention makes use of this property and allows an effective reduction of the averaged leakage information in memory accesses, which are required for the DPA/DEMA, wherein the reduction cannot be cancelled by external attack methods, whereby this kind of attack is made significantly harder or is even prevented.

According to this embodiment, the means for determining the intermediate results on which the final result is based includes one or more look-up tables. An intermediate result is defined as the result of looking up in the look-up table and/or one of the look-up tables using an input date associated with the intermediate result. The individual look-up and/or substitution processes, however, are performed in a random sequence instead of a predetermined constant sequence.

According to a special embodiment of the present invention, the randomness of the execution of the determination of the intermediate results is achieved by randomly determining one of the determinations of an intermediate result as the starting first intermediate result determination from which the determinations of the remaining intermediate results are executed in a predetermined constant cyclical sequence.

The number of the possible execution sequences is limited to the number of the intermediate results in this embodiment, but the implementation is simple as only one random value has to be determined.

The present invention is further advantageous in that it is implementable in existing program codes for cryptographic algorithms in a way that different program code portions do not have to be jumped to randomly to realize the different random execution sequence, but that the random execution sequence may be achieved with one and the same program code only by clever address manipulations and/or pointer manipulations. The attacker therefore cannot draw conclusions as to the randomly determined execution sequence, not even by observing the program counter and/or the program processing profile.

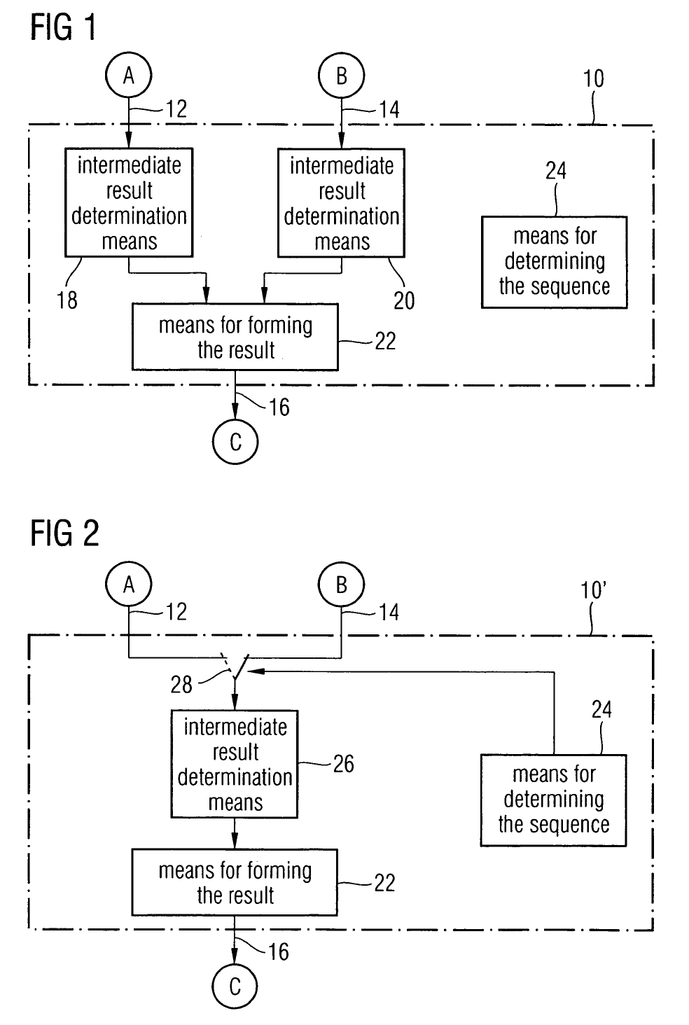

It is to be noted that like elements have been given the same reference numerals in FIGS. 1 and 2 and that a repeated description of the elements has been omitted.

FIG. 1 shows a device for determining a result C according to an embodiment of the present invention. By way of example, the following description assumes that result C is either the result or an intermediate result of a cryptographic algorithm. The device generally indicated by 10 in FIG. 1 determines the result C on the basis of two input operands or input operand sets A and B.

Accordingly, the device 10 includes an input 12 for A, an input 14 for B, and an output 16 for C. Further, the device 10 includes first and second intermediate result determination means 18 and 20, respectively, means 22 for forming the result C from intermediate results of the intermediate result determination means 18, 20, and means 24 for determining an execution sequence.

The intermediate result determination means 18 is connected between the input 12 and the means 22. Accordingly, the intermediate result determination means 20 is connected between the input 14 and the means 22. The means 22 outputs the result C at output 16. The means 24 for determining the sequence operates on corresponding means, such as the means 18 and 20 themselves or means not shown between inputs 12 and 14 on the one hand and the intermediate result determination means 18 and 20 on the other hand, to determine and/or control randomly the sequence of the processing of the input operands A and B by the intermediate result determination means 18, 20, as described in the following.

After the structure of the device 10 of FIG. 1 has been described above, its operation will be described in the following.

The intermediate result determination means 18 and 20 determine an intermediate result from the input operands and/or input operand sets A and B, respectively, according to a predetermined operation. The predetermined operation may, for example, include looking up in a look-up table based on the operand and/or the operand set A and/or B, or the logical and/or arithmetic combining of the input operands of the input operand set A and/or B to obtain the respective intermediate result. An example of an arithmetic combination would be a modular multiplication or modular addition of two input operands.

After having received the intermediate results from the intermediate result determination means 18 and 20, the means 22 forms the result C from the intermediate results of these means. The formation of the result C may, for example, consist only of joining one bit representation of the two intermediate results with a bit representation of the result C. In this case, the means 22 only manifests itself in that the result C is further processed in the further course of the crypto-algorithm execution, or in that the result C represents the result, such as the cipher, of the crypto-algorithm itself. However, the means 22 could further form the result also from the intermediate results by arithmetic or logical operations, such as by arithmetic or logical combination of the two intermediate results, such as a bitwise XOR operation of both intermediate results of the means 18 and 20.

The hardware on which the intermediate result determination means 18 and 20 are based, such as the processor or the memory which is accessed, as discussed in the following, gives away information on the input operands A and/or B to the outside and/or leaks information on the input operands A and/or B. This applies particularly when the operation executed by these means 18 and 20 is a substitution operation, i.e. looking up in a look-up table by a memory access to a stored look-up table. In order to reduce the leakage risk by DPA/DEMA attacks, the means 24 determines in advance, i.e. prior to the execution of the intermediate result determinations by the means 18 and 20, randomly a sequence in which the intermediate result determination means 18 and 20 will determine their respective intermediate result. In the present simple case of only two intermediate results to be determined, it is sufficient that the means 24 randomly determines one of the two values 0 and 1. Depending on which value has been determined randomly, the means 24 causes first one of the two intermediate result determination means 18, 20 to determine its intermediate result from the input date A or B supplied to and/or associated with the same, and only after that the other of the two intermediate result determination means 18, 20 to determine its own intermediate result based on the operand B or A, respectively, associated therewith, and to pass it on to the means 22. For this, the means 24, for example, drives appropriate registers to pass first A to 18 and then B to 20, or vice versa.

The advantage is that the attacker requires a higher number of averagings, in the present case a number of averagings increased by the factor 4, from the current profile and/or the emitted electromagnetic radiation to get to secret information regarding a cryptographic algorithm including the result C, such as a master key.

However, it is to be noted with respect to FIG. 1 that the device 10 may be realized both completely in hardware and also partially in hardware and software. In particular, it would be possible that, in addition to the serial execution of the determination of the intermediate results, as described above, the intermediate result determination means 18 and 20 would also be capable of simultaneous intermediate result determinations. In order to minimize the “idle state” of the two means 18 and 20 in this case caused by the present invention and/or the offset in time caused randomly and artificially in the execution, as there are times when only one of the intermediate result determination means calculates its intermediate result and the other one does not, it could be provided that the intermediate result determination means currently in idle state is used for other purposes than for the determination of the result C, i.e. for example in a process running in parallel on a processor.

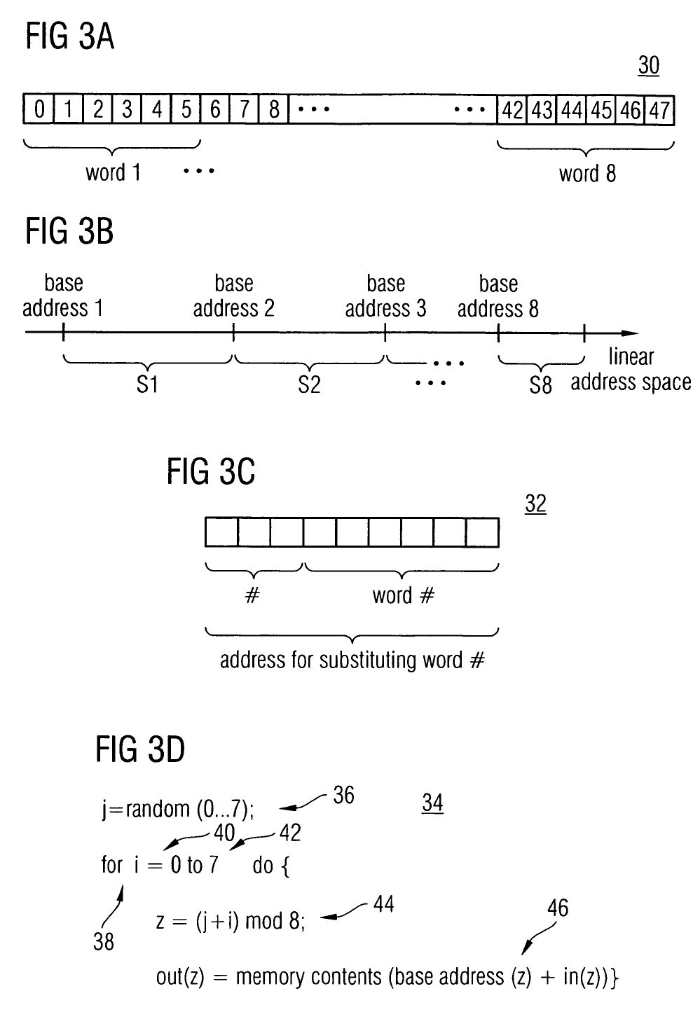

As will be described with respect to the embodiment of FIGS. 3a-3d, however, the operation on which the intermediate result determination means are based may also be a substitution operation and/or looking up in a look-up table by means of a memory access, for example within a chip card with a processor and associated memory. In this case, the intermediate result determination means 18 and 20 are, for example, memory commands which load memory contents from a memory in addresses depending on the input operands A and/or B, wherein the loaded memory contents represent the intermediate results. As is indicated with respect to FIG. 3d, the intermediate result determination means 18 and 20 can even be implemented by the same program code lines. In this case, the intermediate result determination means 18 and 20 are inherently set to a serial intermediate result determination due to the serial program processing. In this case, the means 24 is a program part seeing to it that the program part implementing the means 18 and 20 executes the intermediate result determinations in the randomly determined sequence. In the case of the same program code implementing the means 18 and 20, the two means 18 and 20 only differ by the different memory locations and/or areas in which the look-up table for the intermediate result determination means 18 on the one hand and the look-up table for the intermediate result determination means 20 on the other hand are stored, as will be explained in more detail later on with respect to FIG. 3b by way of example based on a DES algorithm.

In the embodiment of FIG. 1 described above, intermediate result determination means 18 and 20 were used for the determination of the two intermediate results, the means having been different at least with respect to the memory location of the respective look-up table, the respective hardware or the respective program code, or the like. The embodiment described below with respect to FIG. 2 differs from the previous one in that one and the same intermediate result determination means is used for the determination of the two intermediate results. In addition to the two inputs 12, 14, the output 16 and the means 22 and 24, the device of FIG. 2 generally indicated by 10′ therefore only includes a common intermediate result determination means 26 comprising an output connected to an input of the means 22 and an input which is selectively connectable to either the input 12 or the input 14 via switching means 28.

Depending on the randomly determined sequence, the means 24 drives the switching means 28 so that first the input operand and/or input operand set A and only then the input operand and/or input operand set B is forwarded to the intermediate result determination means 26, or vice versa. Effectively, the means 24 thus determines in a random way the sequence of the execution of the determination of the intermediate result obtained from A and the intermediate result obtained from B.

As explained with respect to the embodiment of FIG. 1, the device 10′ may be implemented in hardware or a combination of hardware and software. In the case of an implementation in hardware, the switching means 28 is, for example, a multiplexer whose control input is controlled randomly by the means 24 so that the multiplexer randomly forwards either the operand A or the operand B to the intermediate result determination means 26. In the case of an implementation on the basis of software, the program part implementing the intermediate result determination means 26 is, for example, one that cyclically loads and processes the input operands 12 and 14 provided at predetermined registers in a sequence which it derives from random information which, in turn, were provided to the same by a program part implementing the means 24 at a predetermined memory address. Not only the program code implementing the intermediate result determination means, but also the memory locations which this code utilizes for determining the intermediate result from A and the intermediate result from B, i.e. for example the look-up table, are equal in FIG. 2, in contrast to the embodiment of FIG. 1.

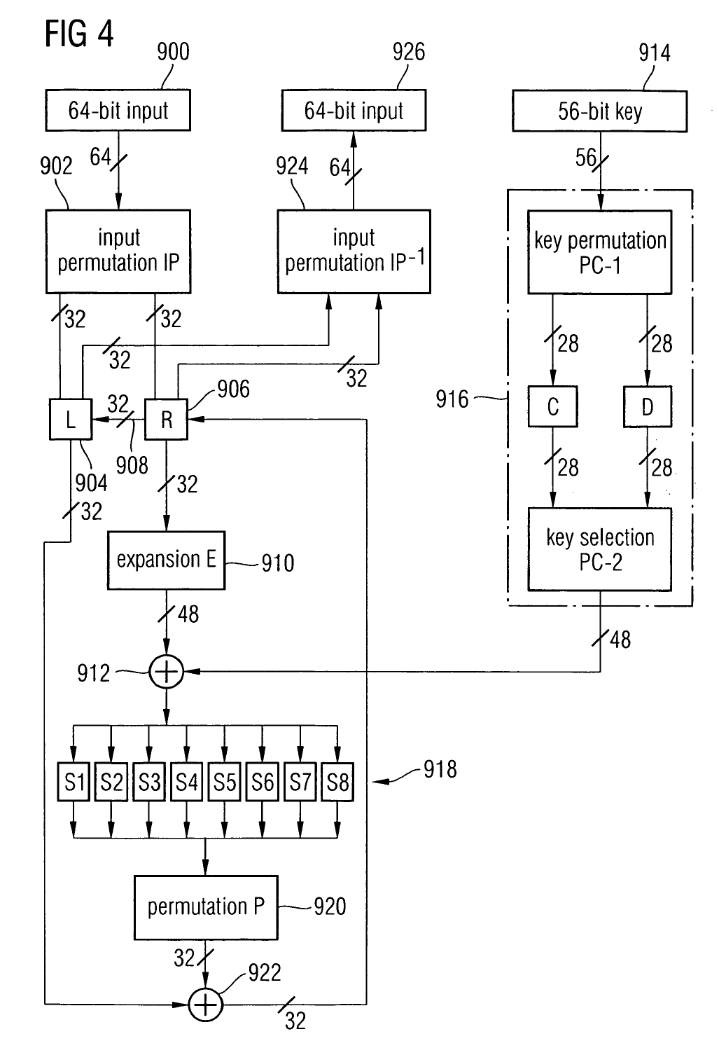

After the embodiments of FIGS. 1 and 2 described generally herein, a specific embodiment of an application of the present invention will be described in the following, namely by means of the example of the substitution operation in the rounds of a DES algorithm indicated by reference numeral 918 in FIG. 4. For avoiding repetitions, see the introductory portion of the description for the description of the DES algorithm.

The substitution operation 918 of a DES algorithm includes eight independent S-box accesses to eight different S-boxes and/or look-up tables S1-S8. Input date to the substitution operation 918 constitutes the 48-bit data block encrypted with the round key and expanded from 32 to 48 bits, illustrated by way of example in FIG. 3 and indicated by reference numeral 30. FIG. 3a represents the 48-bit data block as a row of boxes which are supposed to represent the bits of the input data block 30, wherein the numbering of the boxes specifies the corresponding bit position of the individual bits. As indicated in FIG. 3a, the data block 30 is divided into eight 6-bit words, WORD1-WORD8, which are composed of six different bits of the 48-bit data block 30, respectively, as shown in FIG. 3a.

In order to implement the DES algorithm with regard to its substitution operation, the associated S-boxes and/or look-up tables may be arranged consecutively in a linear address space, as shown by way of example in FIG. 3b. Each S-box S1-S8 is provided to map a 6-bit value associated therewith, i.e. S-box S1 maps WORD1, S-box S2 maps WORD2, etc., to a 4-bit output value which together, in turn, yield the 32-bit output data block which is then subjected to the permutation 920. The size of each S-box is therefore 4·2⁶ bits=32 bytes. According to the embodiment of FIG. 3b, the S-boxes S1-S8 are arranged directly one after the other and thus occupy 8·32 bytes=256 bytes, in all. Each S-box begins at a base address, i.e. base address 1, base address 2, etc.

The access to one of the S-boxes S1-S8 to obtain the output value to the respective word WORD1-WORD8 therein may be performed, with a suitable arrangement of the base address 1 in the linear address space, by means of an address which, with respect to a smallest addressable unit of one half-byte, has the structure exemplarily shown in FIG. 3c and is generally indicated by 32. As can be seen, the access address 32 is a 9-bit address whose three most significant bits (MSBs) are a binary 3-bit representation of the word number # minus 1, and whose six least significant bits (LSBs) are a binary representation and/or the six bits of the 6-bit word word# with the corresponding word number # itself. The 4-bit output word onto which the WORD3 is to be mapped by the S-box S3 is therefore obtained in this embodiment for example by reading the memory contents and/or the half-byte at the address 32 {0, 1, 0, first bit of WORD3, second bit of WORD3, . . . , sixth bit of WORD3}.

According to an embodiment of the present invention, an algorithm code implementing the DES algorithm of FIG. 4 would contain at least one program code portion corresponding to that of FIG. 3d, i.e. a machine code implementing the commands contained in the pseudo code of FIG. 3d, for example, as dictated by a compiler.

The pseudo code portion shown in FIG. 3d, generally indicated by 34, would be responsible for the substitution operation 918 within the DES algorithm code. As can be seen, first a random value between 0 through 7 is assigned to a variable j in the program portion 34. Translated to a machine code, this value would then be stored at a fixed defined memory position. Subsequently, there is the beginning of a program loop at 38 at the beginning of which a counter value i is initialized to zero (40), wherein at the end of the loop passes the counter value i is always incremented by 1 directly before a next pass, and which is terminated when the counter value i exceeds the value 7 after a loop pass (42). Within each loop pass, the counter value i and the random value j are added modulo 8, and the result is given to a variable z (44). In machine code, this would again be done by storing the variable z at a predetermined fixed memory position. As a second step in each program loop, the memory contents at the access address 32 are then read out from a memory array beginning at the base address base address(z) in a step 46, i.e. at the address which results from the base address base address(z) incremented by the offset value and/or the offset address in(z), wherein in(z) is to correspond to the value of the word WORD(z) from the data block 30 and, in machine code, would be obtained, for example, by a LOAD command with respect to a fixedly arranged memory array beginning at a fixed address by means of z as offset value. The result of the read-out process 46 is stored in a one-dimensional, fixedly arranged memory array field of eight memory positions as variable out(z) at the z^{th} position. Translated into machine code, the command line 46 would contain several command lines which, however, always store the result of the readout at one of eight fixed memory locations each of which is associated with a different one of the words WORD1-WORD8.

The function of the program code portion 34 is to determine first randomly by the determination of the random value j in step 36 with which S-box operation S1-S8 among the eight S-box operations S1-S8 the substitution operation is to be begun. After that, all eight S-box operations are performed in the loop 38, each loop 38 being passed through eight times. However, instead of using the loop counter value always beginning at the value 0 to determine the sequence in which the words WORD1-WORD8 are mapped to the corresponding 4-bit words, the value z is used. This means that what is laid down by the program loop 38 in the program code 34 is only a cycling through the S-box operations S1-S8, that, however, the S-box operation which the loop 38 is begun may be varied by setting the variable j prior to loop 38 which is done randomly. In other words, the program code 34 is split into two parts, i.e. a program code part 36 which lays down random information on a random sequence with respect to the execution of the S-box operations at a fixedly determined memory location, and a further program part which accesses this memory location to perform the S-box operations, i.e. accessing the address space, in a sequence indicated by the random information, depending on the random information. The second program part 38 and/or 38-46 accesses the input operands arranged at predetermined fixed positions and, in turn, writes what it reads at these positions in fixed associated memory positions. By lining up and representing the values out(0) . . . out(7) in a 4-bit representation, the array out(0) . . . out(7) forms the 32-bit data block which, in the DES algorithm, is then forwarded to the permutation means 920.

The embodiment of FIG. 3d has shown that the program part 36 assumes the function of the means 24 of FIG. 1, and the program part 38-46 assumes the function of the intermediate result determination means 18 and 20. It has further become apparent that the program code 34 as a whole is always, i.e. independently of the random value j, executed in the same program flow sequence. The reduction of the leakage information is only realized by providing a random value j by a command 36 in a fixed memory location and/or register, the value then being accessed by the other program part 38-46 to fetch and process the input operands A and/or B and/or WORD1-WORD8 stored at fixed positions in a corresponding sequence.

In the embodiment of FIGS. 3a-3d, the look-up tables for the various S-boxes S1-S8 were arranged at different memory locations. The corresponding portions in the linear address space, as shown in FIG. 3b, are cycled through, randomly beginning with one portion. The physical accesses are therefore performed beginning at different locations of the linear address space, depending on the random value j. From this, conclusions could be drawn as to the random value j.

Therefore, the present invention is even more effective when applied to an AES algorithm, in which a substitution operation of 16 independent byte substitutions is performed in the ten AES rounds using the same S-box and/or look-up table. The AES S-box is a mapping of an 8-bit input value to an 8-bit output value, and therefore has a size of 2⁸×8 bits=2⁸ bytes=256 bytes. In the AES algorithm, 16 8-bit words in a 128-bit data block are mapped independently of each other to 16 8-bit output words by the S-box within the substitution operation, the output words together again yielding a 128-bit output data block of the substitution operation.

The program code 34 of FIG. 3d may readily be adapted to an AES algorithm by substituting “15” for “7”, “16” for “8” and “base address” for “base address(z)”, i.e. the one of the single AES S-box. Input values of the program portion 38 would then be the 16 8-bit words in(0)-in(15) arranged in a one-dimensional array, and the output array would be out(0)-out(15). As in the embodiment with respect to the DES algorithm of FIG. 3d, the program portion 38-46 would be fixed, and the random execution sequence would only be realized by using the random value j for manipulating the memory access to load and process the input operands in the randomly beginning cyclical sequence.

With respect to the above description, the following is further to be noted. In the above embodiments, the intermediate results were always obtained based on different input operands A, B and/or WORD1-WORD8. Of course, it would also be possible to determine intermediate results in different sequences which themselves, in turn, are based on the same input operand(s), i.e. A=B and input 12 and input 14 in FIG. 1 are formed by a single input. Further it is to be noted that, although means 22 for forming the result from the intermediate results is provided in FIGS. 1 and 2, such means does not have to be physically present, as shown by the embodiment of FIG. 3d. There, the formation of the result is performed only by storing the output values out(0) . . . out(7) at corresponding memory locations. The result, i.e. the 32-bit data block, is then simply the row of out(0) . . . out(7) without a further read/write operation or the like being necessary. The means 22 was illustrated in FIGS. 1 and 2 only for clarity.

The previous embodiments thus make use of the fact that block ciphers generally consist of several independent S-box accesses, whereby an effective reduction, which cannot be cancelled by external methods, of the averaged leakage information, which is needed for the DPA/DEMA, may be achieved in memory accesses. Thereby, this kind of attack is made significantly harder, if not prevented entirely. According to the embodiment of FIGS. 3a-3d, a series of memory accesses is randomly exchanged in its order from program run to program run. However, this is not performed via different code sequences which are jumped to optionally, but via a clever pointer management and/or pointer manipulation of the pointers which point to the data to be loaded (in(0) . . . in(7)). This is always done via one and the same piece of program code 34. The S-box access in the DES algorithm, as shown in FIGS. 3a-3d, was only a simple example and may be applied to other algorithms, such as the AES algorithm, as described above. Depending on a date in, a new date out is loaded from the associated S-box which substitutes the previous date. In the DES algorithm, this is done eight times, in the AES 16 times.

The operation necessary for this consisted of loading “in(z)” the original date in(z), which was then used as offset to a base address “base address(z)” at 46 of the associated S-box to load the substitute “out(z)”. The sequence in which the S-boxes are processed was made random by choosing, for example in the AES algorithm, a random starting value between 0 through 15 and then loading the S-box in a loop which respectively increments modulo 16. Thus the averaged leakage information may be reduced to 1/16, with the noise remaining the same. This increases the number of necessary averagings by the factor 256 which may be decisive for success or failure of an attack. If some dummy accesses are added, in the AES algorithm for example further virtual S-box accesses 16-31, which are then addressed just as randomly by the pointer arithmetic as described above, the number of necessary averagings is again significantly increased, in the case of further 16 virtual S-box accesses by the factor 1,024.

It is further to be noted that also a complete permutation of the execution sequence could be achieved if, instead of the line 36, a program code portion would be provided in the code of FIG. 3d which would, for example, generate a random permutation of the vector (0,1,2,3,4,5,6,7) and store it at a fixed location for the program portion 38-46.

Further, the present invention is not limited to symmetrical block ciphers as used in the above embodiments, but may also be applied to asymmetrical algorithms.

As discussed above, the inventive scheme for result determination may also be implemented in software, depending on the circumstances. The implementation may be done on a digital storage medium, particularly a floppy disk or a CD with control signals that can be read out electronically, which may cooperate with a programmable computer system so that the corresponding method is performed. In general, the invention thus also consists in a computer program product with a program code stored on a machine-readable carrier for performing the inventive method, when the computer program product runs on a computer. In other words, the invention may thus be realized as a computer program with a program code for performing the method, when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A device for determining a calculation result, comprising:
a unit for determining a first intermediate result and a second intermediate result, wherein the result depends on the first intermediate result and the second intermediate result; and
a unit for randomly determining a sequence in which the unit for determining executes the determination of the first intermediate result and the second intermediate result.

2. The device of claim 1, wherein the unit for determining comprises a unit for deriving a derivation result from a derivation input operand, and the unit for determining is designed to effect that the unit for deriving is supplied with a first input operand as a first derivation input operand to obtain the first intermediate result as the derivation result, and with a second input operand as a second derivation input operand to obtain the second intermediate result as the derivation result, in the randomly determined sequence.

3. The device of claim 1, wherein the unit for determining comprises a first unit for deriving a first derivation result from a first derivation input operand, and a second unit for deriving a second derivation result from a second derivation input operand, and wherein the unit for determining is designed to effect that the first unit for deriving is supplied with a first input operand as the first derivation input operand to obtain the first intermediate result as the first derivation result, and the second unit for deriving is supplied with a second input operand as the second derivation input operand to obtain the second intermediate result as the second derivation result, in the randomly determined sequence.

4. The device of claim 2, wherein the unit for deriving comprises a look-up table and is designed to access a look-up table for deriving the derivation result using the derivation input operand as address to obtain the derivation result.

5. The device of claim 3, wherein the units for deriving comprise a look-up table and are designed to access a look-up table for deriving the derivation result using the derivation input operand as address to obtain the derivation result.

6. The device of claim 2, wherein the first input operand and the second input operand come from different bit positions of an input date.

7. The device of claim 1, further comprising:
a unit for forming the result from the first intermediate result and the second intermediate result.

8. The device of claim 6, wherein the unit for forming is designed to obtain the result by joining or bitwise combining bits of the first intermediate result and bits of the second intermediate result.

9. The device of claim 1, wherein there is a series of N intermediate results, and the unit for determining comprises N look-up tables each of which is associated with a different one of a series of N base addresses, wherein the unit for randomly determining a sequence is designed to determine a random starting value 0≦j<N, and wherein the device further comprises:
a unit for looking up in the look-up table with the j^{th} base address using a j^{th} one of a series of N input operands as an offset address to the j^{th} base address to obtain the j^{th} intermediate result.

10. The device of claim 1, wherein there is a series of N intermediate results, and the unit for determining comprises a look-up table, wherein the unit for determining a sequence is designed to determine a random starting value 0≦j<N, and wherein the device further comprises:
a unit for looking up in the look-up table using a j^{th} one of a series of N input operands as an offset address to a base address of the look-up table to obtain the j^{th} intermediate result.

11. The device of claim 9, wherein the unit for looking up is designed to increment the value j modulo N after looking up to obtain a new value for j, and to repeat the looking up for the new value for j.

12. The device of claim 1, wherein there are N intermediate results on which the result depends, and wherein, among the determinations of the N intermediate results, a cyclical sequence is defined in which the determinations are executed, wherein the unit for determining is designed to determine a determination of one of the N intermediate results randomly, with which the execution of the determinations of the N intermediate results according to the cyclical sequence begins.

13. The device of claim 1, which is part of a cryptography controller.

14. The device of claim 1, wherein the calculation result is part of a final result or intermediate result of a cryptographic algorithm.

15. A method for calculating a result, comprising:
determining a first intermediate result and a second intermediate result;
wherein the result depends on the first intermediate result and the second intermediate result, and wherein the method further comprises:
randomly determining a sequence in which the steps of determining are executed.

16. The method of claim 15, wherein the determining step comprises the step of deriving a derivation result from a derivation input operand by obtaining a first input operand as a first derivation input operand to determine the first intermediate result as the derivation result, and by obtaining a second input operand as a second derivation input operand to determine the second intermediate result as the derivation result, in the randomly determined sequence.

17. The method of claim 16, wherein the determining step comprises the steps of:
deriving a first derivation result from a first derivation input operand by obtaining a first input operand as the first derivation input operand to obtain the first intermediate result as the first derivation result, in the randomly determined sequence; and
deriving a second derivation result from a second derivation input operand by obtaining a second input operand as the second derivation input operand to obtain the second intermediate result as the second derivation result, in the randomly determined sequence.

18. The method of claim 16, further comprising the step of accessing a look-up table for deriving the derivation result using the derivation input operand as address to obtain the derivation result.

19. The method of claim 16, wherein the first input operand and the second input operand come from different bit positions of an input date.

20. The method of claim 15, further comprising the step of forming the result from the first intermediate result and the second intermediate result.

21. The method of claim 20, wherein the forming step comprises the steps of obtaining the result by joining or bitwise combining bits of the first intermediate result and bits of the second intermediate result.

22. The method of claim 15, wherein there is a series of N intermediate results and N look-up tables each of which is associated with a different one of a series of N base addresses,
wherein the step of randomly determining a sequence comprises the step of determining a random starting value 0≦j<N, and
wherein the method further comprises the step of looking up in the look-up table with the j^{th} base address using a j^{th} one of a series of N input operands as an offset address to the j^{th} base address to obtain the j^{th} intermediate result.

23. The method of claim 15, wherein there is a series of N intermediate results and a look-up table,
wherein the determining step comprises the step of determining a random starting value 0≦j<N, and
wherein the method further comprises the step of looking up in the look-up table using a j^{th} one of a series of N input operands as an offset address to a base address of the look-up table to obtain the j^{th} intermediate result.

24. The method of claim 22, wherein the step of looking up comprises the step of incrementing the value j modulo N after looking up to obtain a new value for j, and to repeat the looking up for the new value for j.

25. The method of claim 15, wherein there are N intermediate results on which the result depends, and wherein, among steps of determining the N intermediate results, a cyclical sequence is defined in which the determining steps are executed,
wherein the determining step comprises the step of determining one of the N intermediate results randomly, with which the steps of determining the N intermediate results according to the cyclical sequence begins.

26. The method of claim 15, which is performed in a cryptography controller.

27. The method of claim 15, wherein the calculation result is part of a final result or intermediate result of a cryptographic algorithm.

28. A computer program with a program code for performing the method for calculating a result, when the computer program runs on a computer, the method comprising the steps of determining a first intermediate result and a second intermediate result, wherein the result depends on the first intermediate result and the second intermediate result, and wherein the method further comprises the step of randomly determining a sequence in which the steps of determining are executed.
